(19) United States
(12) Patent Application Publication
(10) Pub. No.: US 2026/0143128 A1
(43) Pub. Date: May 21, 2026

(54) METHOD, APPARATUS, AND MEDIUM FOR POINT CLOUD CODING

(71) Applicants: Douyin Vision Co., Ltd., Beijing (CN); Bytedance Inc., Los Angeles, CA (US)

(72) Inventors: Wenyi WANG, Beijin (CN); Yingzhan XU, Beijing (CN); Bharath VISHWANATH, Los Angeles, CA (US); Kai ZHANG, Los Angeles, CA (US); Li ZHANG, Los Angeles, CA (US)

(21) Appl. No.: 19/445,261

(22) Filed: Jan. 9, 2026

Related U.S. Application Data
(63) Continuation of application No. PCT/CN2024/104827, filed on Jul. 10, 2024.

(30) Foreign Application Priority Data
Jul. 10, 2023 (WO) PCT/CN2023/106648

(51) Int. Cl. H04N 19/14; H04N 19/174; H04N 19/597

(52) U.S. Cl. CPC H04N 19/14; H04N 19/174; H04N 19/597

(57) ABSTRACT

Embodiments of the present disclosure provide a method for point cloud coding. In the method, for a conversion between a current frame of a point cloud sequence and a bitstream of the point cloud sequence, a vertex along an edge of a boundary of at least one slice of the current frame is determined. The conversion is performed based on the vertex. The vertex is included in the bitstream for at least once.

### CROSS-REFERENCE TO RELATED APPLICATIONS

This application is a continuation of International Application No. PCT/CN2024/104827, filed on Jul. 10, 2024, which claims the benefit of International Application No. PCT/CN2023/106648, filed on Jul. 10, 2023. The entire contents of these applications are hereby incorporated by reference in their entireties.

### FIELDS

Embodiments of the present disclosure relates generally to point cloud coding techniques, and more particularly, to vertex determination and indication for point cloud coding.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, for a conversion between a current frame of a point cloud sequence and a bitstream of the point cloud sequence, a vertex along an edge on a boundary of at least one slice of the current frame; and performing the conversion based on the vertex, wherein the vertex is included in the bitstream for at least once. The method in accordance with the first aspect of the present disclosure determining the vertex along the boundary edge of the slice and signal the vertex in the bitstream. In this way, the efficiency for point cloud geometry coding can be improved.

In a second aspect, an apparatus for point cloud coding is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a point cloud sequence which is generated by a method performed by a point cloud processing apparatus. The method comprises: determining a vertex along an edge on a boundary of at least one slice of a current frame of the point cloud sequence; and generating the bitstream based on the vertex, wherein the vertex is included in the bitstream for at least once.

In a fifth aspect, a method for storing a bitstream of a point cloud sequence is proposed. The method comprises: determining a vertex along an edge on a boundary of at least one slice of a current frame of the point cloud sequence; generating the bitstream based on the vertex, wherein the vertex is included in the bitstream for at least once; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder in accordance with some embodiments of the present disclosure;

FIG. 3 illustrates a block diagram that illustrates an example point cloud decoder in accordance with some embodiments of the present disclosure;

FIG. 4 illustrates a flowchart of the improved point cloud geometry information coding in accordance with embodiments of the present disclosure;

FIG. 5 illustrates a flowchart of a method for point cloud coding in accordance with embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

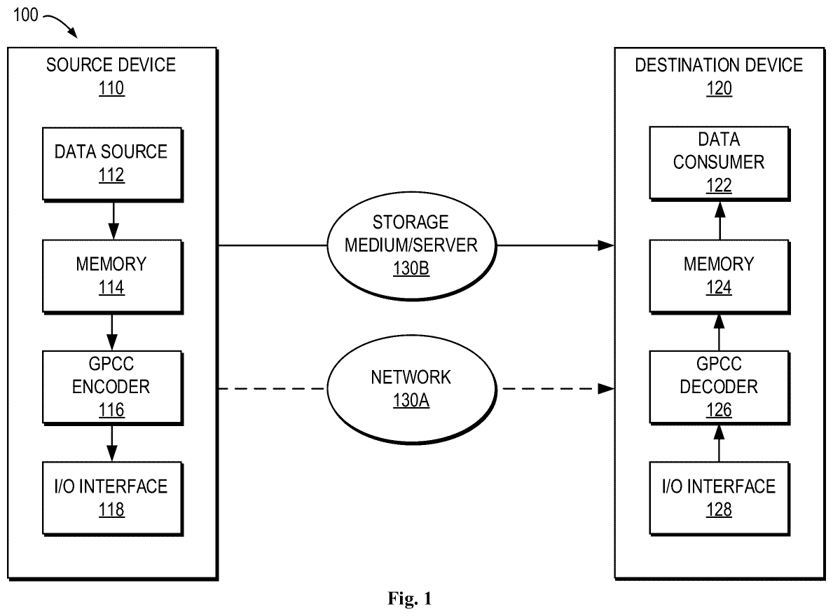

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

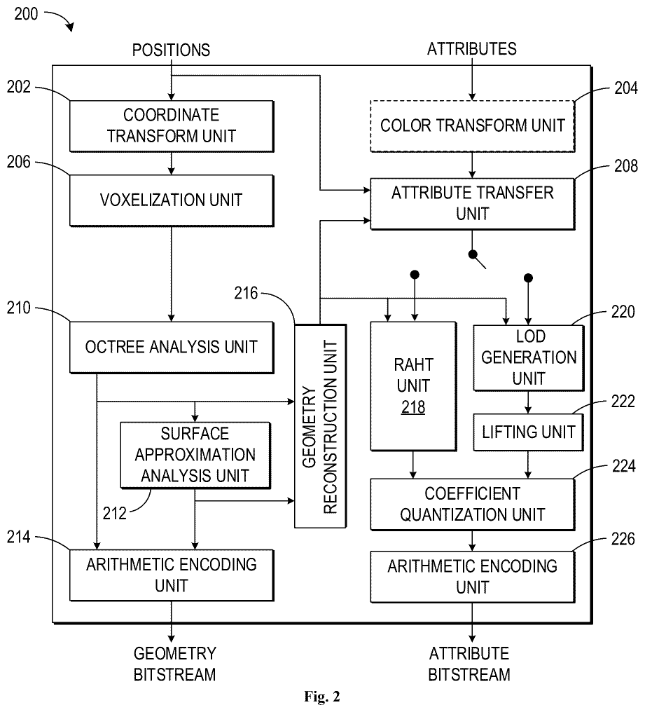

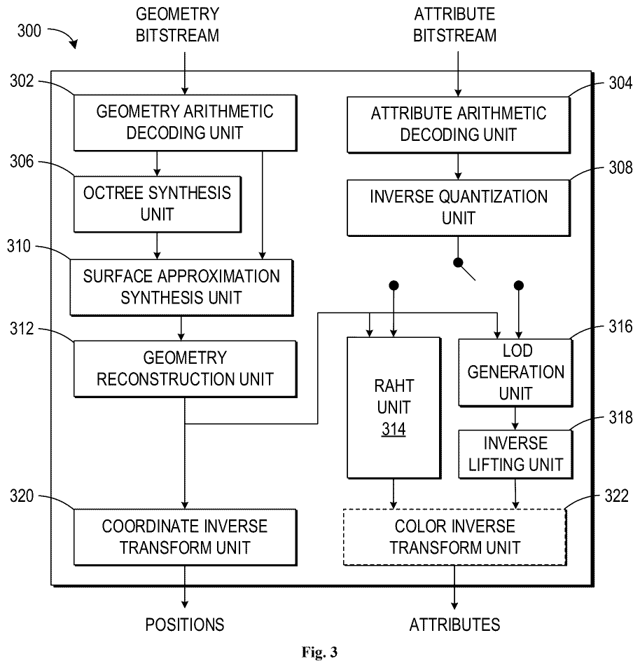

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively, or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. BRIEF SUMMARY

This disclosure is related to point cloud coding technologies. Specifically, it is related to point cloud geometry information coding. The ideas may be applied individually or in various combination, to any point cloud coding standard or non-standard point cloud codec, e.g., the being-developed Geometry based Point Cloud Compression (G-PCC).

### 2.

Abbreviations

| | |
|---|---|
| G-PCC | Geometry based Point Cloud Compression |
| MPEG | Moving Picture Experts Group |
| 3DG | 3D Graphics Coding Group |
| CFP | Call For Proposal |
| V-PCC | Video-based Point Cloud Compression |
| RAHT | Region-Adaptive Hierarchical Transform |
| SPS | Sequence Parameter Set |
| APS | Attribute Parameter Set |
| GPS | Geometry Parameter Set. |

### 3. Introduction

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on.

### 3.1 Octree Geometry Compression

Point cloud codec can process the various information in different ways. Usually there are many optional tools in the codec to support the coding and decoding of geometry information and attribute information respectively. Among geometry coding tools in G-PCC, octree geometry compression has an important influence for point cloud geometry coding performance.

In G-PCC, one of important point cloud geometry coding tools is octree geometry compression, which leverages point cloud geometry spatial correlation. If geometry coding tools is enabled, a cubical axis-aligned bounding box, associated with octree root node, will be determined according to point cloud geometry information. Then the bounding box will be subdivided into 8 sub-cubes, which are associated with 8 sub-nodes of root node (a cube is equivalent to node hereafter). An 8-bit code is then generated by specific order to indicate whether the 8 sub-nodes contain points separately, where one bit is associated with one sub-node. The bit associated with one sub-node is named occupancy bit and the 8-bit code generated is named occupancy code. The generated occupancy code will be signaled according to the occupancy information of neighbor node. Then only the nodes which contain points will be subdivided into 8 sub-nodes furtherly. The process will perform recursively until the node size is 1. So, the point cloud geometry information is converted into occupancy code sequences.

In decoder side, occupancy code sequences will be decoded and the point cloud geometry information can be reconstructed according to the occupancy code sequences.

A breadth-first scanning order will be used for the octree. In one level of the octree, the octree node will be scanned in a Morton order. If the coordinate of one node is represented by N bits, the coordinate (X, Y, Z) of the node can be represented as follows.

$$X = ( {x}_{N - 1} {x}_{N - 2} … {x}_{1} {x}_{0} ) ,$$

$$Y = ( {y}_{N - 1} {y}_{N - 2} … {y}_{1} {y}_{0} ) ,$$

$$Z = ( {z}_{N - 1} {z}_{N - 2} … {z}_{1} {z}_{0} ) .$$

Its Morton code can be represented as follows.

$$M = ( {x}_{N - 1} {y}_{N - 1} {z}_{N - 1} {x}_{N - 2} {y}_{N - 2} {z}_{N - 2} … {x}_{1} {y}_{1} {z}_{1} {x}_{0} {y}_{0} {z}_{0} ) .$$

The Morton order is the order from small to large according to Morton code.

### 3.2 Inferred Direct Coding Mode (IDCM)

The octree representation, or more generally any tree representation, is efficient at representing points with a spatial correlation because trees tend to factorize the higher order bits of the point coordinates. For an octree, each level of depth refines the coordinates of points within a sub-node by one bit for each component at a cost of eight bits per refinement. Further compression is obtained by entropy coding the split information associated with each tree node.

However, if one node of octree contains isolated point, directly coding their relative coordinates in the node is better than octree representation. Because there are no other points in the node, no spatial correlation can be used. Directly coding point coordinates in a node/sub-node is called Direct Coding Mode (DCM). On the other hand, time complexity will be reduced using DCM because the octree recursive split process cannot be performed.

In G-PCC, every node will be judged whether it is eligible for DCM or not according to specific eligibility condition, which is called Inferred Direct Coding Mode (IDCM). If a node is eligible for DCM, a binary flag is coded to signal if the DCM is applied (flag=1) or not (flag=0) to the node. If the flag is equal to 1, then points belonging to the associated volume are directly coded using the DCM. Otherwise (the flag is equal to 0), the tree coding process continues for the current node.

Currently, there are two eligibility conditions for IDCM.
└ parent-based-eligibility. There is only one occupied child (=the current node) at parent-node level, AND the grand-parent node has at most two occupied children (=the parent node+possibly one other node).
┌ 6N eligibility. There is only one occupied child (=the current node) at parent-node level, AND there is no occupied neighbour N (among the six neighbours sharing a face with the current cube associated with the current node).

### 3.3 Trisoup Geometry Compression

Trisoup codec is a geometry coding option that represents the object surface as a series of triangle mesh. It is applicable for a dense surface point cloud. The decoder generates point cloud from the mesh surface in the specified voxel granularity so that it assures the density of the reconstructed point cloud. Trisoup codec is applied in slice, which is a coding unit.

If the Trisoup geometry codec is used, then the parameter trisoup_node_size defines the size of the triangle nodes in unit of voxel. The octree encoding and decoding stop at leaf level [symbol] , in which case the leaf nodes of the octree represent cubes of width W= [symbol] , or blocks, and the octree is said to be pruned. In the latter case, Inferred Direct Coding Mode is not allowed.

### 3.3.1 Determining Vertices

If trisoup_node_size >0, then the blocks are 2×2×2 or larger, and it is necessary to represent the collection of voxels within the block by some model. Geometry is represented within each block as a surface that intersects each edge of the block at most once. Since there are 12 edges of a block, there can be at most 12 such intersections within a block. Each such intersection is called a vertex. A vertex along an edge is detected if and only if there is at least one occupied voxel adjacent to the edge among all blocks that share the edge. The position of a detected vertex along an edge is the average position along the edge of all such voxels adjacent to the edge among all blocks that share the edge.

### 3.3.2 Entropy Encoding of Vertices

Vertices, nominally being intersections of a surface with edges of a block, are shared across neighbouring blocks, not only guaranteeing continuity across blocks of the reconstructed surface, but also reducing the number of bits required to code the collection of vertices. The set of vertices is coded in two steps. In a first step, the set of all the unique edges (or segments) of occupied blocks is computed, and a bit vector (or segment indicator) determines which segments contain a vertex and which do not. In a second step, for each segment that contains a vertex, the position of the vertex along the segment is uniformly scalar quantized to a small number of levels, typically equal to the block width if the geometric spatial resolution is desired to approximate the voxel resolution, but it could be any number of levels. The segment indicators and the vertex positions are entropy coded by an arithmetic coder. The geometry bitstream becomes a compound bitstream comprising octree, segment indicator, and vertex position bitstreams.

### 3.3.3 Surface Reconstruction

Then the vertices on the edges of a block determine a surface through the block. The surface is a non-planar polygon and triangulated into multiple triangles by a specified process. To derive a decoded geometry point cloud from the trisoup in the specified voxel resolution, it is checked if each voxel in the bounding box intersects with the triangles.

### 3.3 Slice

In G-PCC, a point cloud frame can be is divided into several slices which can be independently encoded and decoded. A slice is a list of points. There are many advantages about the slice based coding structure, such as supporting parallel encoding and decoding, avoiding error propagation and supporting low latency, etc.

### 3.4 Coding Parameter Classification

There are some coding parameters in the encoder to control the encoding of point cloud. Some of them are signaled to the decoder to support the decoding process. The parameters can be classified and stored in several clusters according to the affected part of each parameter, such as geometry parameter set (GPS), attribute parameter set (APS) and sequence parameter set (SPS). The parameters that control the geometry coding tools are stored in GPS. The parameters that control the attribute coding tools are stored in APS. For example, the parameters that describe the attribute category of point cloud sequence and the data accuracy of coding process are stored in SPS.

### 3.5 Problems

The Existing Designs for Point Cloud Geometry Information Coding have the Following Problems:
1. The trisoup codec is applied in slice. On slice boundary, only the blocks in the slice is used to determine the vertex along the boundary edge. However, this can not guarantee the continuity across blocks of the reconstructed surface and will result in the reconstructed surface gap in visual on slice boundary.
2. On slice boundary, the vertex of an edge will be determined and signaled in all the slices which contain the boundary edge. In other words, the vertex of an edge on slice boundary will be determined and signaled multiple times. This will increase the number of bits required to code the collection of vertices and reduce compression efficiency.

### 4. Detailed Solutions

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.
1) The vertex along an edge on the slice boundary may be determined by the voxels from multiple blocks.
   a. In one example, these voxels may be occupied voxels.
   b. In one example, these voxels may be adjacent to the boundary edge.
   c. In one example, these voxels may be determined by a distance threshold.
      i. In one example, the distance may be the Euclidean distance, the Manhattan distance, the Chebyshev distance and so on.
      ii. In one example, the distance may be the distance between these voxels and the boundary edge.
      iii. In one example, if the distance between one voxel and the boundary edge is less than the distance threshold, the voxel may be used to determine the vertex.
      iv. In one example, if the distance between one voxel and the boundary edge is less than or equal to the distance threshold, the voxel may be used to determine the vertex.
   d. In one example, these blocks may share the boundary edge.
   e. In one example, these blocks may come from different slices.
      i. In one example, these blocks may be on the slice boundary.
2) The vertex along an edge on the slice boundary may be determined and signaled at least once.
   a. In one example, all the slices may be coded in the specified order.
   b. In one example, the vertex along an edge on the slice boundary may be signaled in any slice which contains the boundary edge.
   c. In one example, the vertex along an edge on the slice boundary may be signaled in multiple slices which contain the boundary edge.
   d. In one example, the vertex along an edge on the slice boundary may be signaled in only one slice which contains the boundary edge.
      i. In one example, the slice may be the first coded slice which contain the boundary edge.
      ii. In one example, the slice may be the last coded slice which contain the boundary edge.
3) An indicator (e.g., being binary value) may be used to indicate whether the proposed method is enabled.
   a. In one example, the indicator may be signaled in the bitstream.
   b. Alternatively, the indicator may be inferred in decoder and/or encoder side.
   c. In one example, the indicator may be consistent in one coding unit.
      i. In one example, the coding unit may be frame.
      ii. In one example, the coding unit may be tile.
      iii. In one example, the coding unit may be slice.
   d. In one example, the indicator may be consistent in one point cloud sequence.
   e. The indicator may be signaled conditionally.
   f. The indicator may be binarized with fixed-length coding, EG coding, (truncated) unary coding, etc.
   g. The indicator may be coded with at least one context in arithmetic coding.
   h. The indicator may be bypass coded.
4) Whether to and/or how to apply a method disclosed above may be signaled from encoder to decoder in a bitstream/frame/tile/slice/octree/etc.

### 5. EMBODIMENTS

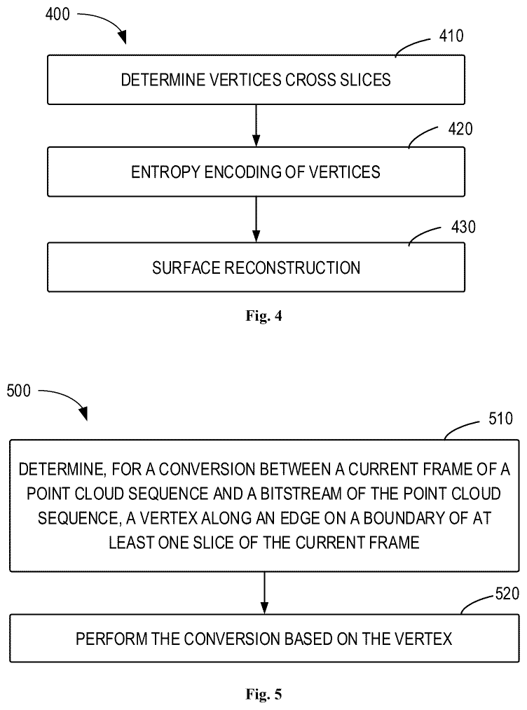

An example of the coding flow 400 for the improved point cloud geometry information coding is depicted in FIG. 4 As illustrated, at block 410, vertices cross slices are determined. At block 420, entropy encoding of vertices is performed. At block 430, surface reconstruction is performed.

More details will be further discussed below. FIG. 5 illustrates a flowchart of a method 500 for point cloud coding in accordance with embodiments of the present disclosure. The method 500 is implemented for a conversion between a current coding unit such as a current frame of a point cloud sequence and a bitstream of the point cloud sequence.

At block 510, for a conversion between a current frame of a point cloud sequence and a bitstream of the point cloud sequence, a vertex along an edge of a boundary of at least one slice of the current frame is determined.

At block 520, the conversion is performed based on the vertex. The vertex is included in the bitstream for at least once. In some embodiments, the conversion includes encoding the current frame into the bitstream. Alternatively, or in addition, in some embodiments, the conversion includes decoding the current frame from the bitstream.

The method 500 enables determining and signaling the vertex along an edge of the slice boundary for at least once. Thus, the effectiveness and efficiency of point cloud geometry coding can be improved.

In some embodiments, the vertex along the edge of the boundary is included in a single slice of the current frame, the single slice comprising the edge of the boundary. As used herein, the edge of the boundary may also be referred to as a boundary edge. In some embodiments, a plurality of slices may share a same boundary edge. The vertex along the boudary edge may be included in one of these plurality of slices. In this way, the vertex of the edge on slice boundary may be determined and signaled only once. The number of bits require to code the collection of vertices can be reduced. The compression efficiency can thus be improved.

In some embodiments, the single slice comprises the first coded slice comprising the edge of the boundary. Alternatively, the single slice comprises the last coded slice comprising the edge of the boundary.

In some embodiments, the vertex along the edge of the boundary is included in a plurality of slices of the current frame, each of the plurality of slices comprising the edge of the boundary. The plurality of slices including the vertex may be a partial of all slices containing the boundary edge. That is, instead of signaling the vertex in all slices containing the boundary edge, only a partial of these slices may include the vertex. The number of bits for coding the collection of vertices can be reduced. The compression efficiency can thus be improved.

In some embodiments, the plurality of slices comprises all slices comprising the edge of the boundary.

In some embodiments, the plurality of slices is coded in a specified order.

In some embodiments, determining the vertex comprises: determining the vertex based on at least one voxel from a plurality of blocks of the current frame.

In some embodiments, the at least one voxel comprises at least one occupied voxel.

In some embodiments, the at least one voxel is adjacent to the edge of the boundary.

In some embodiments, the method 500 further comprises: determining a plurality of distances between a plurality of candidate voxels and the edge of the boundary; and determining the at least one voxel based on the plurality of distances and a distance threshold.

In some embodiments, the plurality of distances is determined based on a distance metric, the distance metric comprising one of: a Euclidean distance, a Manhattan distance, or a Chebyshev distance.

In some embodiments, determining the at least one voxel comprises: in accordance with a determination that a distance between a candidate voxel and the edge of the boundary is less than the distance threshold, determining the candidate voxel as the at least one voxel.

In some embodiments, determining the at least one voxel comprises: in accordance with a determination that a distance between a candidate voxel and the edge of the boundary is less than or equal to the distance threshold, determining the candidate voxel as the at least one voxel.

In some embodiments, the plurality of blocks shares the edge of the boundary.

In some embodiments, the plurality of blocks is associated with a plurality of slices of the current frame.

In some embodiments, the plurality of blocks is on a boundary of the plurality of slices.

In some embodiments, an indicator indicates enabling of the method, the indicator comprising a binary value.

In some embodiments, the indicator is included in the bitstream.

In some embodiments, the indicator is included in the bitstream based on a condition.

In some embodiments, the indicator is inferred by at least one of: a decoder side, or an encoder side for the conversion.

In some embodiments, the indicator is consistent in a coding unit of the point cloud sequence, the coding unit comprising one of: a frame, a tile, or a slice.

In some embodiments, the indicator is consistent in the point cloud sequence.

In some embodiments, the indicator is binarized with one of: a fixed-length coding, an Exponential Golomb (EG) coding, a unary coding, or a truncated unary coding.

In some embodiments, the indicator is coded with at least one context in arithmetic coding.

In some embodiments, the indicator is bypass coded.

In some embodiments, whether to and/or how to apply the method is indicated from an encoder to a decoder in one of: the bitstream, a frame, a tile, a slice, or an octree in the bitstream.

According to further embodiments of the present disclosure, a non-transitory computer-readable recording medium is provided. The non-transitory computer-readable recording medium stores a bitstream of a point cloud sequence which is generated by a method performed by an apparatus for point cloud coding. In the method, a vertex along an edge on a boundary of at least one slice of a current frame of the point cloud sequence is determined. The bitstream is generated based on the vertex. The vertex is included in the bitstream for at least once.

According to still further embodiments of the present disclosure, a method for storing bitstream of a point cloud sequence is provided. In the method, a vertex along an edge on a boundary of at least one slice of a current frame of the point cloud sequence is determined. The bitstream is generated based on the vertex. The vertex is included in the bitstream for at least once. The bitstream is stored in a non-transitory computer-readable recording medium.

Implementations of the present disclosure can be described in view of the following clauses, the features of which can be combined in any reasonable manner.

Clause 1. A method for point cloud coding, comprising: determining, for a conversion between a current frame of a point cloud sequence and a bitstream of the point cloud sequence, a vertex along an edge on a boundary of at least one slice of the current frame; and performing the conversion based on the vertex, wherein the vertex is included in the bitstream for at least once.

Clause 2. The method of clause 1, wherein the vertex along the edge of the boundary is included in a single slice of the current frame, the single slice comprising the edge of the boundary.

Clause 3. The method of clause 2, wherein the single slice comprises one of: the first coded slice comprising the edge of the boundary, or the last coded slice comprising the edge of the boundary.

Clause 4. The method of clause 1, wherein the vertex along the edge of the boundary is included in a plurality of slices of the current frame, each of the plurality of slices comprising the edge of the boundary.

Clause 5. The method of clause 4, wherein the plurality of slices comprises all slices comprising the edge of the boundary.

Clause 6. The method of clause 4 or 5, wherein the plurality of slices is coded in a specified order.

Clause 7. The method of any of clauses 1-6, wherein determining the vertex comprises: determining the vertex based on at least one voxel from a plurality of blocks of the current frame.

Clause 8. The method of clause 7, wherein the at least one voxel comprises at least one occupied voxel.

Clause 9. The method of clause 7, wherein the at least one voxel is adjacent to the edge of the boundary.

Clause 10. The method of clause 7, further comprising: determining a plurality of distances between a plurality of candidate voxels and the edge of the boundary; and determining the at least one voxel based on the plurality of distances and a distance threshold.

Clause 11. The method of clause 10, wherein the plurality of distances is determined based on a distance metric, the distance metric comprising one of: a Euclidean distance, a Manhattan distance, or a Chebyshev distance.

Clause 12. The method of clause 10 or 11, wherein determining the at least one voxel comprises: in accordance with a determination that a distance between a candidate voxel and the edge of the boundary is less than the distance threshold, determining the candidate voxel as the at least one voxel.

Clause 13. The method of clause 10 or 11, wherein determining the at least one voxel comprises: in accordance with a determination that a distance between a candidate voxel and the edge of the boundary is less than or equal to the distance threshold, determining the candidate voxel as the at least one voxel.

Clause 14. The method of any of clauses 7-13, wherein the plurality of blocks shares the edge of the boundary.

Clause 15. The method of any of clauses 7-14, wherein the plurality of blocks is associated with a plurality of slices of the current frame.

Clause 16. The method of clause 15, wherein the plurality of blocks is on a boundary of the plurality of slices.

Clause 17. The method of any of clauses 1-16, wherein an indicator indicates enabling of the method, the indicator comprising a binary value.

Clause 18. The method of clause 17, wherein the indicator is included in the bitstream.

Clause 19. The method of clause 18, wherein the indicator is included in the bitstream based on a condition.

Clause 20. The method of clause 17, wherein the indicator is inferred by at least one of: a decoder side, or an encoder side for the conversion.

Clause 21. The method of any of clauses 17-20, wherein the indicator is consistent in a coding unit of the point cloud sequence, the coding unit comprising one of: a frame, a tile, or a slice.

Clause 22. The method of any of clauses 17-20, wherein the indicator is consistent in the point cloud sequence.

Clause 23. The method of any of clauses 17-22, wherein the indicator is binarized with one of: a fixed-length coding, an Exponential Golomb (EG) coding, a unary coding, or a truncated unary coding.

Clause 24. The method of any of clauses 17-22, wherein the indicator is coded with at least one context in arithmetic coding.

Clause 25. The method of any of clauses 17-24, wherein the indicator is bypass coded.

Clause 26. The method of any of clauses 1-25, wherein whether to and/or how to apply the method is indicated from an encoder to a decoder in one of: the bitstream, a frame, a tile, a slice, or an octree in the bitstream.

Clause 27. The method of any of clauses 1-26, wherein the conversion comprises encoding the current frame into the bitstream.

Clause 28. The method of any of clauses 1-26, wherein the conversion comprises decoding the current frame from the bitstream.

Clause 29. An apparatus for point cloud coding comprising a processor and a non-transitory memory with instructions thereon, wherein the instructions upon execution by the processor, cause the processor to perform a method in accordance with any of clauses 1-28.

Clause 30. A non-transitory computer-readable storage medium storing instructions that cause a processor to perform a method in accordance with any of clauses 1-28.

Clause 31. A non-transitory computer-readable recording medium storing a bitstream of a point cloud sequence which is generated by a method performed by a point cloud processing apparatus, wherein the method comprises, determining a vertex along an edge on a boundary of at least one slice of a current frame of the point cloud sequence; and generating the bitstream based on the vertex, wherein the vertex is included in the bitstream for at least once.

Clause 32. A method for storing a bitstream of a point cloud sequence, comprising: determining a vertex along an edge on a boundary of at least one slice of a current frame of the point cloud sequence; generating the bitstream based on the vertex, wherein the vertex is included in the bitstream for at least once; and storing the bitstream in a non-transitory computer-readable recording medium.

### Example Device

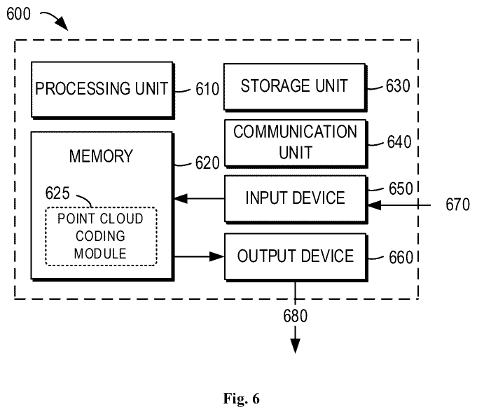

FIG. 6 illustrates a block diagram of a computing device 600 in which various embodiments of the present disclosure can be implemented. The computing device 600 may be implemented as or included in the source device 110 (or the GPCC encoder 116 or 200) or the destination device 120 (or the GPCC decoder 126 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement point cloud encoding/decoding in embodiments of the present disclosure. The memory 620 may include one or more point cloud coding modules 625 having one or more program instructions. These modules are accessible and executable by the processing unit 610 to perform the functionalities of the various embodiments described herein.

In the example embodiments of performing point cloud encoding, the input device 650 may receive point cloud data as an input 670 to be encoded. The point cloud data may be processed, for example, by the point cloud coding module 625, to generate an encoded bitstream. The encoded bitstream may be provided via the output device 660 as an output 680.

In the example embodiments of performing point cloud decoding, the input device 650 may receive an encoded bitstream as the input 670. The encoded bitstream may be processed, for example, by the point cloud coding module 625, to generate decoded point cloud data. The decoded point cloud data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method for point cloud coding, comprising:
determining, for a conversion between a current frame of a point cloud sequence and a bitstream of the point cloud sequence, a vertex along an edge on a boundary of at least one slice of the current frame; and
performing the conversion based on the vertex, wherein the vertex is included in the bitstream for at least once.

2. The method of claim 1, wherein the vertex along the edge of the boundary is included in one of: a single slice of the current frame or a plurality of slices of the current frame, the single slice comprising the edge of the boundary, and each of the plurality of slices comprising the edge of the boundary.

3. The method of claim 2, wherein the single slice comprises one of:
the first coded slice comprising the edge of the boundary, or
the last coded slice comprising the edge of the boundary, or
wherein the plurality of slices comprises all slices comprising the edge of the boundary.

4. The method of claim 3, wherein the plurality of slices is coded in a specified order.

5. The method of claim 1, wherein determining the vertex comprises:
determining the vertex based on at least one voxel from a plurality of blocks of the current frame.

6. The method of claim 5, wherein the at least one voxel comprises at least one occupied voxel, or wherein the at least one voxel is adjacent to the edge of the boundary.

7. The method of claim 5, further comprising:
determining a plurality of distances between a plurality of candidate voxels and the edge of the boundary; and
determining the at least one voxel based on the plurality of distances and a distance threshold.

8. The method of claim 7, wherein the plurality of distances is determined based on a distance metric, the distance metric comprising one of: a Euclidean distance, a Manhattan distance, or a Chebyshev distance, or
wherein determining the at least one voxel comprises:
in accordance with a determination that a distance between a candidate voxel and the edge of the boundary is less than the distance threshold, determining the candidate voxel as the at least one voxel, or
in accordance with a determination that a distance between a candidate voxel and the edge of the boundary is less than or equal to the distance threshold, determining the candidate voxel as the at least one voxel.

9. The method of claim 5, wherein the plurality of blocks shares the edge of the boundary, or
wherein the plurality of blocks is associated with a plurality of slices of the current frame.

10. The method of claim 9, wherein the plurality of blocks is on a boundary of the plurality of slices.

11. The method of claim 1, wherein an indicator indicates enabling of the method, the indicator comprising a binary value.

12. The method of claim 11, wherein the indicator is included in the bitstream, or
wherein the indicator is inferred by at least one of: a decoder side, or an encoder side for the conversion.

13. The method of claim 12, wherein the indicator is included in the bitstream based on a condition, or
wherein the indicator is consistent in a coding unit of the point cloud sequence, the coding unit comprising one of: a frame, a tile, or a slice, or
wherein the indicator is consistent in the point cloud sequence.

14. The method of claim 11, wherein the indicator is binarized with one of: a fixed-length coding, an Exponential Golomb (EG) coding, a unary coding, or a truncated unary coding, or
wherein the indicator is coded with at least one context in arithmetic coding.

15. The method of claim 11, wherein the indicator is bypass coded.

16. The method of claim 1, wherein whether to and/or how to apply the method is indicated from an encoder to a decoder in one of: the bitstream, a frame, a tile, a slice, or an octree in the bitstream.

17. The method of claim 1, wherein the conversion comprises encoding the current frame into the bitstream, or
wherein the conversion comprises decoding the current frame from the bitstream.

18. The method of claim 1, wherein the conversion comprises: generating the bitstream from the point cloud sequence, and
the method further comprises: storing the bitstream in a non-transitory computer-readable recording medium.

19. An apparatus for processing point cloud data comprising a processor and a non-transitory memory with instructions thereon, wherein the instructions upon execution by the processor, cause the processor to:
determine, for a conversion between a current frame of a point cloud sequence and a bitstream of the point cloud sequence, a vertex along an edge on a boundary of at least one slice of the current frame; and
perform the conversion based on the vertex, wherein the vertex is included in the bitstream for at least once.

20. A non-transitory computer-readable storage medium storing instructions that cause a processor to perform operations comprising:
determining, for a conversion between a current frame of a point cloud sequence and a bitstream of the point cloud sequence, a vertex along an edge on a boundary of at least one slice of the current frame; and
performing the conversion based on the vertex, wherein the vertex is included in the bitstream for at least once.
